(19) United States
(12) Patent Application Publication
(10) Pub. No.: US 2006/0271453 A1
(43) Pub. Date: Nov. 30, 2006

(54) Master-feeder hedge fund product structure

(75) Inventors: Jeff Landle, New York, NY (US); Alexander Schweickhardt, Vienna (AT)

Correspondence Address: SCHULTE ROTH & ZABEL LLP;ATTN: JOEL E. LUTZKER, 919 THIRD AVENUE, NEW YORK, NY, 10022, US

(73) Assignee: H.A.R.D.T. GROUP Investments AG, Vienna (AT)

(21) Appl. No.: 11/136,967

(22) Filed: May 25, 2005

(51) Int. Cl. G06Q 40/00

(52) U.S. Cl. 705/35

(57) ABSTRACT

A master-feeder investment structure including at least one top tier multi-strategy portfolio, at least one intermediate tier multi-strategy portfolio; and at least one lower tier single strategy fund. The single strategy fund makes a plurality of hedge fund investments in accordance with its predetermined single strategy.

### BACKGROUND OF THE INVENTION

The invention relates to the field of managing and product structuring of collective investment pools commonly referred to as “hedge funds.”

Many, but not all, hedge fund strategies tend to hedge against downturns in the markets being traded. Hedge funds are flexible in their investment options (i.e., they can use short selling, leverage, and derivatives such as puts, calls, options, futures, etc.).

Hedge funds employ a variety of investment strategies, some of which use leverage and derivatives while others are more conservative and employ little or no leverage. Many hedge fund strategies seek to reduce market risk specifically by shorting equities or derivatives. Performance of hedge funds employing different strategies, particularly relative value strategies, is not dependent on the direction of the bond or equity markets—unlike conventional equity or mutual funds (unit trusts), which are generally 100% exposed to market risk.

Most hedge funds are highly specialized, relying on the specific expertise of the manager or management team.

Investing in hedge funds tends to be favored by more sophisticated investors (including many Swiss and other private banks) who have lived through, and understand the consequences of, major stock market corrections. Many endowments and pension funds also allocate assets to hedge funds.

The popular misconception is that all hedge funds are volatile—that they all use global macro strategies and place large directional bets on stocks, currencies, bonds, commodities, and gold, while employing a significant amount of leverage. In reality, less than 5% of hedge funds are global macro funds. Most hedge funds use derivatives only for hedging or don't use derivatives at all, and many use little to no leverage. Several strategies commonly used by present hedge funds are outlined below.

In accordance with an aggressive growth strategy, a hedge fund invests in equities expected to experience acceleration in growth of earnings per share. They are typically characterized by generally high P/E ratios, little to no dividends; smaller and micro cap stocks which are expected to experience rapid growth, and include sector specialist funds such as technology, banking, or biotechnology. This strategy hedges by shorting equities where earnings disappointment is expected or by shorting stock indexes and tends to be “long-biased.”

In accordance with a distressed securities strategy, a hedge fund buys equity, debt, or trade claims at deep discounts of companies in or facing bankruptcy or reorganization. This strategy profits from the market's lack of understanding of the true value of the deeply discounted securities as well as the fact that the majority of institutional investors cannot own below investment grade securities. (This selling pressure creates the deep discount.) Results generally are not dependent on the direction of the markets.

In accordance with an emerging markets strategy, a hedge fund invests in equity or debt of emerging (less mature) markets, which tend to have higher inflation and volatile growth. Short selling is not permitted in many emerging markets, and, therefore, effective hedging is often not available, although Brady debt can be partially hedged via U.S. Treasury futures and currency markets.

In accordance with an income strategy, a hedge fund invests with primary focus on yield or current income rather than solely on capital gains. This strategy may utilize leverage to buy bonds and sometimes fixed income derivatives in order to profit from principal appreciation and interest income.

In accordance with a macro strategy, a hedge fund aims to profit from changes in global economies, typically brought about by shifts in government policy which impact interest rates, in turn affecting currency, stock, and bond markets. Such hedge fund participates in all major markets—equities, bonds, currencies and commodities—though not always at the same time and uses leverage and derivatives to accentuate the impact of market moves. It also utilizes hedging, but leveraged directional bets tend to make the largest impact on performance.

In accordance with a market neutral—arbitrage strategy, a hedge fund attempts to hedge out most market risk by taking offsetting positions, often in different securities of the same issuer. For example, the manager can be long in convertible bonds and short the underlying issuers equity. This strategy may use futures to hedge out interest rate risk and focuses on obtaining returns with low or no correlation to both the equity and bond markets. These relative value strategies include fixed income arbitrage, mortgage backed securities, capital structure arbitrage, and closed-end fund arbitrage.

In accordance with a market neutral—securities hedging strategy, a hedge fund invests equally in long and short equity portfolios generally in the same sectors of the market. Thus, market risk is greatly reduced, but effective stock analysis and stock picking is essential to obtaining meaningful results. Leverage may be used to enhance returns. Usually this strategy has low or no correlation to the market and sometimes uses market index futures to hedge out systematic (market) risk. Relative benchmark index is usually T-bills.

In accordance with a market timing strategy, a hedge fund allocates assets among different asset classes depending on the manager's view of the economic or market outlook. Portfolio emphasis may swing widely between asset classes. Unpredictability of market movements and the difficulty of timing entry and exit from markets adds to the volatility of this strategy.

In accordance with an opportunistic strategy, hedge fund's investment theme changes from strategy to strategy as opportunities arise to profit from events such as IPOs, sudden price changes often caused by an interim earnings disappointment, hostile bids, and other event-driven opportunities. This strategy may utilize several of these investing styles at a given time and is not restricted to any particular investment approach or asset class.

In accordance with a multi strategy, a hedge fund's investment approach is diversified by employing various strategies simultaneously to realize short- and long-term gains. Other strategies may include systems trading such as trend following and various diversified technical strategies. This style of investing allows the manager to overweight or underweight different strategies to best capitalize on current investment opportunities.

In accordance with a short selling strategy, a hedge fund sells securities short in anticipation of being able to re-buy them at a future date at a lower price due to the manager's assessment of the overvaluation of the securities, or the market, or in anticipation of earnings disappointments often due to accounting irregularities, new competition, change of management, etc. This strategy is often used as a hedge to offset long-only portfolios and by those who feel the market is approaching a bearish cycle.

In accordance with a special situations strategy, a hedge fund invests in event-driven situations such as mergers, hostile takeovers, reorganizations, or leveraged buy outs. This strategy may involve simultaneous purchase of stock in companies being acquired, and the sale of stock in its acquirer, hoping to profit from the spread between the current market price and the ultimate purchase price of the company. It may also utilize derivatives to leverage returns and to hedge out interest rate and/or market risk. Results are generally not dependent on direction of market.

In accordance with a value strategy, a hedge fund invests in securities perceived to be selling at deep discounts to their intrinsic or potential worth. Such securities may be out of favor or under-followed by analysts. Long-term holding, patience, and strong discipline are often required until the ultimate value is recognized by the market.

“Fund of funds” is a relatively novel currently utilized mechanism for structuring a hedge fund product. A fund of funds mixes and matches hedge funds and other pooled investment vehicles. This blending of different strategies and asset classes aims to provide a more stable long-term investment return than any of the individual funds. Returns, risk, and volatility can be controlled by the mix of underlying strategies and funds. Capital preservation is generally an important consideration of such funds. Volatility depends on the mix and ratio of strategies employed.

A disadvantage of typical “funds of funds” managers is that “funds of funds” managers cannot select hedge fund portfolios with any single investor in mind, as opposed to the generalized portfolio objectives of the aggregate group of investors in their “funds of funds.” However, different investors have very different particular objectives and risk tolerance levels as well as different core portfolios which they are seeking to diversify. Therefore, there is a substantial need in the industry for a product individually tailored to each investor.

Another disadvantage of a typical hedge fund is its non-transparency. Clients do not typically have an access to their holdings and exposures.

### SUMMARY OF THE INVENTION

It is an object of the present invention to provide a hedge fund product allowing for complete flexibility with respect to choices of strategy, asset allocation, and volatility. A client can establish, target, tailor, and adjust exposures through multi strategy funds of funds, single strategy funds of funds, asset allocations, and leverage ratio structures. Clients can invest directly in the provided products or customize investment structures to fit their individual tax, liquidity, and regulatory needs.

In accordance with one general aspect of the present invention, a master-feeder investment structure is provided, including at least one top tier multi-strategy portfolio, at least one intermediate tier multi-strategy portfolio; and at least one lower tier single strategy fund. The single strategy fund makes a plurality of hedge fund investments in accordance with its predetermined single strategy.

In accordance with another general aspect of the present invention, a master-feeder investment structure is provided, including at least one top tier multi-strategy portfolio, two intermediate tier multi-strategy portfolios and multiple lower tier single strategy funds. Each single strategy fund makes a plurality of hedge fund investments in accordance with its predetermined single strategy. Intermediate tier multi-strategy portfolios invest in the selected lower tier single strategy funds in accordance with their predetermined multi-strategy. The top tier multi-strategy portfolio invests in the intermediate tier multi-strategy portfolios and/or directly in one or more lower single strategy funds.

In accordance with yet another general aspect of the present invention, a master-feeder investment method is provided, including establishing at least one top tier multi-strategy portfolio; establishing at least one intermediate tier multi-strategy portfolio; and establishing at least one lower tier single strategy fund making a plurality of hedge fund investments in accordance with its predetermined single strategy.

In accordance with a further general aspect of the present invention, a master-feeder investment method is provided, including establishing a plurality of lower tier single strategy funds, each single strategy fund making a plurality of hedge fund investments in accordance with its predetermined single strategy; establishing a first intermediate tier multi-strategy portfolio investing in at least one fund selected from the plurality of lower tier single strategy funds in accordance with its predetermined multi-strategy; establishing a second intermediate tier multi-strategy portfolio investing in at least one fund selected from the plurality of lower tier single strategy funds in accordance with its predetermined multi-strategy; and establishing at least one top tier multi-strategy portfolio investing in the first intermediate tier multi-strategy portfolio, the second intermediate tier multi-strategy portfolio and directly in at least one of the plurality of lower tier single strategy funds.

The structure and method of the present invention provides a transparent, individually tailored, flexible and diversified investment process.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

The invention is illustrated by way of example and not limitation and the figures of the accompanying drawings in which like references denote like or corresponding parts, and in which:

FIG. 1 is schematic diagram of the master feeder structure in accordance with the present invention.

FIG. 2 is a schematic diagram of alpha-beta categorization of hedge fund investments.

### DETAILED DESCRIPTION OF THE PREFERRED EMBODIMENT AND THE DRAWINGS

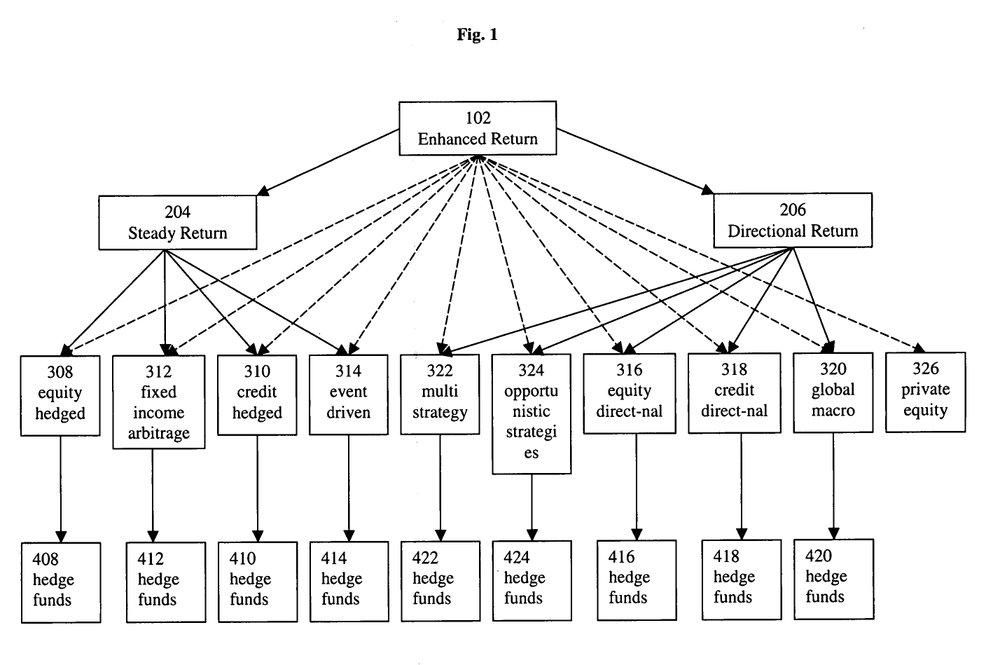

In accordance with the preferred embodiment of the present invention, a multi-tier master-feeder hedge fund structure 100 is provided, as shown in FIG. 1. The multi-tier master-feeder hedge fund structure 100 includes a first level multi-strategy gamma portfolio 102, a second level multi-strategy alpha portfolio 204 and a second level multi-strategy beta portfolio 206. Each portfolio 102, 204 and 206 invests directly in a plurality of single-strategy funds of funds in accordance with its predetermined multi-strategic approach.

In accordance with the preferred embodiment, alpha portfolio 204 is a steady return multi-strategy portfolio. Accordingly, the alpha portfolio 204 invests in alpha equity hedged fund of funds 308, alpha credit hedged fund of funds 310, alpha fixed income arbitrage fund of funds 312 and alpha event driven fund of funds 314 (each of these funds of funds is discussed in more detail below). Investments in other funds of funds, including beta funds of funds and private equity, are also possible, as long as the steady return approach of the alpha portfolio is preserved. Each fund of funds, in turn, makes a plurality of hedge fund investments in accordance with its predetermined strategy. In addition to investing in funds of funds, alpha portfolio may also make direct investments in the underlying hedge funds according to its steady return multi-strategy.

In accordance with the preferred embodiment, beta portfolio 206 is preferably a directional return multi-strategy portfolio. Accordingly, beta portfolio 206 preferably invests in beta equity directional fund of funds 316, beta credit directional fund of funds 318, beta global macro fund of funds 320, multi strategy fund of funds 322 and opportunistic fund of funds 324 (each of these funds of funds is discussed in more detail below). Investments in other funds of funds, including alpha funds of funds and private equity, are also possible, as long as the directional return approach of the beta portfolio is preserved. Each fund of funds, in turn, makes a plurality of hedge fund investments in accordance with its predetermined strategy. In addition to investing in funds of funds, beta portfolio may also make direct investments in the underlying hedge funds according to its directional return multi-strategy.

As shown in FIG. 1, gamma portfolio 102 is an enhanced return multi-strategy portfolio. In accordance with its enhanced return multi-strategic approach, gamma portfolio 102 may invest directly into any of the single-strategy alpha funds of funds and/or single strategy beta funds of funds. Gamma portfolio 102 may also invest directly in a private equity fund 326 and in any of the underlying hedge funds. In addition to investing in a plurality of single-strategy funds of funds directly, gamma portfolio 102 may at least partially invest in the multi-strategy alpha portfolio 204 and multi-strategy beta portfolio 206.

All multi-strategy portfolios may invest directly in hedge fund investments 408-424, in accordance with their predetermined investment strategies.

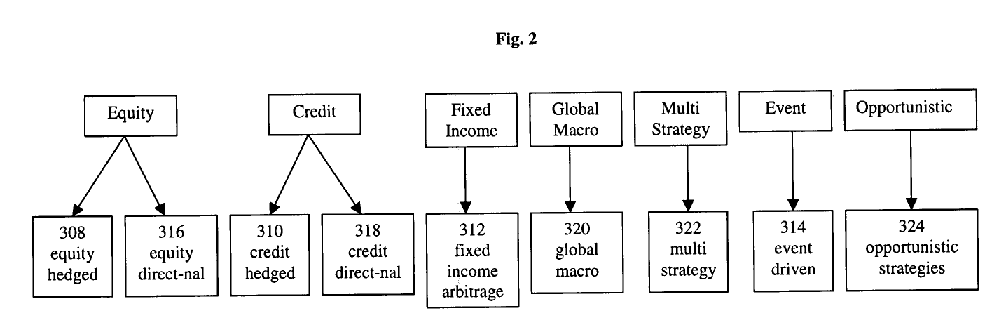

As shown in FIG. 2, all possible investments are classified into different predetermined single strategies. These predetermined single strategies may then be further categorized as an alpha or beta strategy. It should be noted, however, that any other single or multiple strategy can be utilized with the present invention. The invention is not limited to the strategies discussed herein. Additionally, the invention is not limited to having a single first level multi-strategy portfolio and two second level multi-strategy portfolios. Any other number of multi-strategy portfolios can be utilized.

Hedge fund investments 408 of the alpha equity hedged single-strategy fund of funds 308 are designed to capture pricing inefficiencies in the equity markets between related securities, primarily through stock selection. Managers preferably employ both long and short equity positions, with the resulting portfolios having little or no exposure to the direction of the equity markets. Because leverage is rarely employed, its impact on returns is generally minimal. Returns should preferably exhibit low cyclically, volatility, and correlation to equity markets.

Hedge fund investments 412 of the alpha fixed income arbitrage single-strategy fund of funds 312 seek to exploit pricing anomalies between related fixed income securities and anticipated interest rate moves. Managers preferably invest in a variety of fixed income instruments and utilize hedges to reduce or eliminate interest rate exposure. The portfolios often have low duration, and leverage is usually high. Returns for this strategy should exhibit low cyclically and should not be affected by market trends in general. Returns and volatility of this strategy tend to be higher than those of other strategies.

Hedge fund investments 410 of the alpha credit hedged single-strategy fund of funds 310 consist primarily of positions in the credit sensitive portion of fixed income markets. Managers typically invest in long corporate credit versus other credits within a firm's capital structure or paired against a short credit of another corporation. Credit derivatives and swaps may be used for portfolio construction or hedging purposes. Portfolios normally target profits independent from market movements and are typically duration neutral. Interest rate risk is usually hedged out of the portfolio and leverage is used on a moderate level. In comparison to other fixed income strategies, this strategy has moderate returns volatility and correlation expectations. Alpha credit hedged strategy 310 has a lower exposure to the credit markets (i.e., higher credit quality, less leverage, more hedging) than the beta credit directional strategy 318.

Hedge fund investments 414 of the alpha event driven single-strategy fund of funds 314 focus on companies that could benefit from the valuation disparities created by significant announced or expected corporate transactions. These may include spin offs, mergers, takeovers, restructurings, liquidations and stock buybacks. Although these strategies are not directly affected by changes in market direction they can be sensitive to movements in credit spreads liquidity volatility and/or the regulatory environment. Leverage may be utilized. The return volatility and correlation expectations for this strategy are moderate when compared to those of other hedge strategies.

Hedge fund investments 416 of the beta equity directional single-strategy fund of funds 316 seek to generate profits from a combination of active stock selection and capturing directional moves in the equity markets. Market exposure is actively managed depending on the perceived opportunity set and the portfolios comprising this group may be net long or short at any point in time. Leverage can be employed, but net market exposure should generally average less than 100% in either direction. While some of the individual portfolios may be concentrated, diversification is maintained through minimal overlap among the hedge funds' holdings. The returns of this strategy are cyclical and tend to be higher in bullish equity markets. Compared to other strategies, this strategy has mid to high return expectations with higher correlation to the equity markets.

Hedge fund investments 418 of the beta credit directional single-strategy fund of funds 318 consist of positions in the credit sensitive portion of fixed income markets. These investments can be net long corporate or net short credit and hedge much of the interest rate risk. Credit derivatives and swaps may be used for portfolio construction or hedging purposes. The sub strategies in this group differ in terms of portfolio duration and amount of leverage employed, although leverage is typically used on a moderate level. In comparison to other fixed income strategies, this strategy has medium return volatility and correlation expectations. Credit directional single-strategy fund of funds 318 has a higher exposure to the credit markets (i.e., lower credit quality, more leverage, less hedging) than the alpha credit hedged single-strategy fund of funds 310.

Managers of hedge fund investments 420 of the beta global macro single-strategy fund of funds 320 utilize macroeconomic forecasts to identify opportunities and invest in a variety of markets, such as equities, fixed income, currencies, and commodities. Movements in these asset classes may be caused by shifts in monetary and fiscal policies, political events, or global supply and demand dynamics. Although most macro managers employ a discretionary approach, some may use quantitative/systematic methods as part or all of the investment process. Leverage is generally moderate to high. The performance of this strategy tends to be cyclical and dependent on market trends, pricing dislocations, and the relative strength of the global economies. The return and volatility expectations for this strategy are typically higher when compared to those of other strategies. Correlation of returns to equity strategies tends to be low.

Hedge fund investments 422 of the beta multi strategy fund of funds 322 include investments in the global markets and allocate capital among different hedge strategies. Typical allocations include convertible bond arbitrage, capital structure arbitrage, fixed income arbitrage, statistical arbitrage, share class arbitrage, equity relative value, long/short equity and event driven strategies. Hedge fund managers of beta multi strategy funds of funds 322 are able to allocate capital relatively quickly among strategies and markets in response to an opportunity. Leverage is selectively employed and differs from manager to manager and strategy. Beta multi strategy fund of funds 322 has higher returns and volatility in comparison to other lower risk strategies and exhibits little or no correlation to markets because of the range of investments employed.

Hedge fund investments 424 of the beta opportunistic strategies fund of funds 324 may serve to hedge portfolio risks resulting from large fluctuations in credit premiums liquidity and volatility which often characterize market dislocations. Investments will typically include options swaps and other derivative instruments in an attempt to extract profit from pricing discrepancies and changes in volatility and spreads. Other unique strategies may also be included if deemed to provide special opportunities for diversification and hedging of portfolio risks.

In the preferred embodiment, private equity fund 326 invests in pools that invest in venture capital opportunities, development capital, leverage buy out and management, recovery and distressed opportunities, mezzanine situations, PIPE investments and other investments designed to capture those innovative private equity investment opportunities created by the market place that so do not fit in an existing category.

As shown in FIG. 1, in one preferred embodiment of the present invention, gamma portfolio 102 allocates its investments between the multi-strategy alpha portfolio 204, the multi-strategy beta portfolio 206, and the various single-strategy funds including the private equity fund 326. As discussed above, gamma portfolio 102 may also make direct investments in the underlying hedge funds, in accordance with the strategy of the gamma portfolio. Any feasible allocation of assets may be utilized for these investments.

The master-feeder structure of the present invention allows its users to efficiently and individually put together investment portfolios for their clients, in accordance with clients' individual risk tolerances, short term goals, long term goals and other preferences.

In the master-feeder structure of the present invention, clients have ready access to their holdings and exposures through a preferred on-line access to their portfolios, via a secure, password-protected web site. The web site preferably includes manager names and descriptions, market and portfolio commentary, performance, strategy and manager allocations, risk transparency, printed reports with the same comprehensive data, and a clearly understandable investment platform and process. Clients also have access to the investment and marketing professionals.

The preferred embodiments of the invention can be implemented on one or more computer(s) and/or one or more network of computer(s), such as a local area network (LAN), a wide area network (WAN), the Internet and/or another network. In various embodiments, one or more server(s), client computer(s), application computer(s) and/or other computer(s) can be utilized to implement one or more aspect of the invention. Illustrative computers can include, e.g.: a central processing unit; memory (e.g., RAM, etc.); digital data storage (e.g., hard drives, optical disks, flash drives, etc.); input/output ports (e.g., parallel and/or serial ports, etc.); data entry devices (e.g., key boards, etc.); etc. Client computers may contain, in some embodiments, browser software for interacting with the server(s), such as, for example, using hypertext transfer protocol (HTTP) to make requests of the server(s) via the Internet or the like.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Other undescribed variations or modifications may be possible. For example, where multiple alternative embodiments are described, in many cases it will be possible to combine elements of different embodiments, or to combine elements of the embodiments described here with other modifications or variations that are not expressly described. Many of those undescribed variations, modifications and variations are within the literal scope of the following claims, and others are equivalent.

We claim as follows:

1. A master-feeder investment structure comprising:
at least one top tier multi-strategy portfolio;
a first intermediate tier multi-strategy portfolio and a second intermediate tier multi-strategy portfolio; and
a plurality of lower tier single strategy funds,
wherein each of said single strategy funds makes a plurality of hedge fund investments in accordance with its predetermined single strategy, wherein said first intermediate tier multi-strategy portfolio invests in at least one fund selected from said plurality of lower tier single strategy funds in accordance with its predetermined multi-strategy, wherein said second intermediate tier multi-strategy portfolio invests in at least one fund selected from said plurality of lower tier single strategy funds in accordance with its predetermined multi-strategy, and wherein said top tier multi-strategy portfolio invests in said first intermediate tier multi-strategy portfolio, said second intermediate tier multi-strategy portfolio and directly in at least one of said plurality of lower tier single strategy funds.

2. The master-feeder investment structure according to claim 1, wherein said at least one top tier multi-strategy portfolio is an enhanced return portfolio.

3. The master-feeder investment structure according to claim 1, wherein said first intermediate tier multi-strategy portfolio is a steady return portfolio.

4. The master-feeder investment structure according to claim 1, wherein said second intermediate tier multi-strategy portfolio is a directional return portfolio.

5. The master-feeder investment structure according to claim 1, wherein said plurality of lower tier single strategy funds comprises an equity hedged fund.

6. The master-feeder investment structure according to claim 1, wherein said plurality of lower tier single strategy funds comprises a fixed income arbitrage fund.

7. The master-feeder investment structure according to claim 1, wherein said plurality of lower tier single strategy funds comprises a credit hedged fund.

8. The master-feeder investment structure according to claim 1, wherein said plurality of lower tier single strategy funds comprises an event driven fund.

9. The master-feeder investment structure according to claim 1, wherein said plurality of lower tier single strategy funds comprises an equity directional fund.

10. The master-feeder investment structure according to claim 1, wherein said plurality of lower tier single strategy funds comprises a credit directional fund.

11. The master-feeder investment structure according to claim 1, wherein said plurality of lower tier single strategy funds comprises a global macro fund.

12. The master-feeder investment structure according to claim 1 further comprising a lower tier multi-strategy fund, wherein said second intermediate tier multi-strategy portfolio invests in said lower tier multi-strategy fund.

13. The master-feeder investment structure according to claim 1 further comprising a lower tier multi-strategy fund, wherein said first intermediate tier multi-strategy portfolio invests in said lower tier multi-strategy fund.

14. The master-feeder investment structure according to claim 1 further comprising a lower tier opportunistic strategies fund, wherein said second intermediate tier multi-strategy portfolio invests in said lower tier opportunistic strategies fund.

15. The master-feeder investment structure according to claim 1 further comprising a lower tier opportunistic strategies fund, wherein said first intermediate tier multi-strategy portfolio invests in said lower tier opportunistic strategies fund.

16. The master-feeder investment structure according to claim 1 further comprising a lower tier private equity fund.

17. The master-feeder investment structure according to claim 16, wherein said top tier multi-strategy portfolio invests in said lower tier private equity fund.

18. The master-feeder investment structure according to claim 17, wherein said top tier multi-strategy portfolio makes a plurality of direct hedge fund investments in accordance with its predetermined multi-strategy.

19. The master-feeder investment structure according to claim 1, wherein said top tier multi-strategy portfolio makes a plurality of direct hedge fund investments in accordance with its predetermined multi-strategy.

20. The master-feeder investment structure according to claim 1, wherein said first intermediate tier multi-strategy portfolio makes a plurality of direct hedge fund investments in accordance with its predetermined multi-strategy.

21. The master-feeder investment structure according to claim 1, wherein said second intermediate tier multi-strategy portfolio makes a plurality of direct hedge fund investments in accordance with its predetermined multi-strategy.

22. A master-feeder investment method comprising the steps of:
establishing a plurality of lower tier single strategy funds, each of said single strategy funds making a plurality of hedge fund investments in accordance with its predetermined single strategy;
establishing a first intermediate tier multi-strategy portfolio investing in at least one fund selected from said plurality of lower tier single strategy funds in accordance with its predetermined multi-strategy;
establishing a second intermediate tier multi-strategy portfolio investing in at least one fund selected from said plurality of lower tier single strategy funds in accordance with its predetermined multi-strategy; and
establishing at least one top tier multi-strategy portfolio investing in said first intermediate tier multi-strategy portfolio, said second intermediate tier multi-strategy portfolio and directly in at least one of said plurality of lower tier single strategy funds.

23. The master-feeder investment method according to claim 22, wherein said at least one top tier multi-strategy portfolio is an enhanced return portfolio.

24. The master-feeder investment method according to claim 22, wherein said first intermediate tier multi-strategy portfolio is a steady return portfolio.

25. The master-feeder investment method according to claim 22, wherein said second intermediate tier multi-strategy portfolio is a directional return portfolio.

26. The master-feeder investment method according to claim 22, wherein said plurality of lower tier single strategy funds comprises an equity hedged fund.

27. The master-feeder investment method according to claim 22, wherein said plurality of lower tier single strategy funds comprises a fixed income arbitrage fund.

28. The master-feeder investment method according to claim 22, wherein said plurality of lower tier single strategy funds comprises a credit hedged fund.

29. The master-feeder investment method according to claim 22, wherein said plurality of lower tier single strategy funds comprises an event driven fund.

30. The master-feeder investment method according to claim 22, wherein said plurality of lower tier single strategy funds comprises an equity directional fund.

31. The master-feeder investment method according to claim 22, wherein said plurality of lower tier single strategy funds comprises a credit directional fund.

32. The master-feeder investment method according to claim 22, wherein said plurality of lower tier single strategy funds comprises a global macro fund.

33. The master-feeder investment method according to claim 22 further comprising a step of using said second intermediate tier multi-strategy portfolio to invest in a lower tier multi-strategy fund.

34. The master-feeder investment method according to claim 22 further comprising a step of using said first intermediate tier multi-strategy portfolio to invest in a lower tier multi-strategy fund.

35. The master-feeder investment method according to claim 22 further comprising a step of using said second intermediate tier multi-strategy portfolio to invest in a lower tier opportunistic strategies fund.

36. The master-feeder investment method according to claim 22 further comprising a step of using said first intermediate tier multi-strategy portfolio to invest in a lower tier opportunistic strategies fund.

37. The master-feeder investment method according to claim 22 further comprising a step of investing in a lower tier private equity fund.

38. The master-feeder investment method according to claim 37, wherein said step of investing in a lower tier private equity fund is accomplished by said top tier multi-strategy portfolio.

39. The master-feeder investment method according to claim 38, wherein said top tier multi-strategy portfolio makes a plurality of direct hedge fund investments in accordance with its predetermined multi-strategy.

40. The master-feeder investment method according to claim 22, wherein said top tier multi-strategy portfolio makes a plurality of direct hedge fund investments in accordance with its predetermined multi-strategy.

41. The master-feeder investment method according to claim 22, wherein said first intermediate tier multi-strategy portfolio makes a plurality of direct hedge fund investments in accordance with its predetermined multi-strategy.

42. The master-feeder investment method according to claim 22, wherein said second intermediate tier multi-strategy portfolio makes a plurality of direct hedge fund investments in accordance with its predetermined multi-strategy.

43. The master-feeder investment method according to claim 22 further comprising a step of classifying a plurality of hedge fund investments into a variety of said predetermined single strategies.

44. A master-feeder investment structure comprising:
at least one top tier multi-strategy portfolio;
at least one intermediate tier multi-strategy portfolio; and
at least one lower tier single strategy fund,
wherein said single strategy fund makes a plurality of hedge fund investments in accordance with its predetermined single strategy.

45. The master-feeder investment structure according to claim 44, wherein said intermediate tier multi-strategy portfolio invests in said at least one lower tier single strategy fund.

46. The master-feeder investment structure according to claim 44, wherein said intermediate tier multi-strategy portfolio makes a plurality of direct hedge fund investments in accordance with its predetermined multi-strategy.

47. The master-feeder investment structure according to claim 44, wherein said top tier multi-strategy portfolio invests in said intermediate tier multi-strategy portfolio.

48. The master-feeder investment structure according to claim 44, wherein said top tier multi-strategy portfolio directly invests in said at least one lower tier single strategy fund.

49. The master-feeder investment structure according to claim 44, wherein said top tier multi-strategy portfolio makes a plurality of direct hedge fund investments in accordance with its predetermined multi-strategy.

50. A master-feeder investment method comprising the steps of:
establishing at least one top tier multi-strategy portfolio;
establishing at least one intermediate tier multi-strategy portfolio; and
establishing at least one lower tier single strategy fund making a plurality of hedge fund investments in accordance with its predetermined single strategy.

51. The master-feeder investment method according to claim 50 further comprising a step of causing said intermediate tier multi-strategy portfolio to invests in said at least one lower tier single strategy fund.

52. The master-feeder investment method according to claim 50 further comprising a step of causing said intermediate tier multi-strategy portfolio to make a plurality of direct hedge fund investments in accordance with its predetermined multi-strategy.

53. The master-feeder investment method according to claim 50 further comprising a step of causing said top tier multi-strategy portfolio to invest in said intermediate tier multi-strategy portfolio.

54. The master-feeder investment method according to claim 50 further comprising a step of causing said top tier multi-strategy portfolio to directly invest in said at least one lower tier single strategy fund.

55. The master-feeder investment method according to claim 50 further comprising a step of causing said top tier multi-strategy portfolio to make a plurality of direct hedge fund investments in accordance with its predetermined multi-strategy.
